(19) United States
(12) Patent Application Publication
(10) Pub. No.: US 2018/0063147 A1
(43) Pub. Date: Mar. 1, 2018

(54) NETWORK CONTENT RATING BASED ON PUBLIC RATING DATABASE

(71) Applicant: Fortinet, Inc., Sunnyvale, CA (US)

(72) Inventor: Michael F. Chalmandrier-Perna, Sunnyvale, CA (US)

(73) Assignee: Fortinet, Inc., Sunnyvale, CA (US)

(21) Appl. No.: 15/246,114

(22) Filed: Aug. 24, 2016

(51) Int. Cl. H04L 29/06; G06F 21/62; G06F 17/30

(52) U.S. Cl. CPC H04L 63/102; G06F 21/6218; H04L 63/0245; H04L 63/0272; G06F 17/30867; H04L 63/20

(57) ABSTRACT

Systems and methods for inspecting/analyzing a data stream to identify one or more attributes of content associated with the data stream, and apply appropriate content filtering based thereon are provided. According to one embodiment, the data stream is in a form of one or more interactions between a client device and a server associated with a service provider that delivers, streams or authorizes access to digital content by subscribers of the service provider. An attribute of the digital content is identified by a network security device by parsing the data stream. A rating for the digital content is determined by the network security device with reference to a public rating database based on the attribute. Access to the digital content is then blocked or allowed by the network security device by applying a matching content filtering rule based the determined rating.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2016, Fortinet, Inc.

### BACKGROUND

### Field

Embodiments of the present invention generally relate to content rating. In particular, embodiments of the present invention relate to systems and methods for rating network content based on public rating database(s), and filtering the content based on content rating-based rule(s).

### Description of the Related Art

With about 4 billion Internet users and about a billion websites, the Internet is the largest content repository and continues to grow. There is a need in certain information technology (IT) infrastructures/environments to block network traffic based on certain attributes of the network traffic and/or attributes of the content associated with the network traffic. In educational settings, for example, US regulations require access to adult material to be prevented. Due to content classification being an inexact science, among other issues, existing content filtering approaches tend to be overly inclusive regarding blocked content, thereby significantly limiting access to otherwise allowable content.

There is a need for an ability on the part of network security devices to accurately identify appropriate content filtering rules based on any kind of “data in motion” (e.g., interactions between a browser and an external video server associated with a video streaming service, interactions between a gaming system platform and an external game server to allow a gamer to play a locally stored digital rights management (DRM)-protected game and interactions with Software as a Service (SaaS) and cloud applications to access services) and apply the content filtering rules to the associated content at line speed.

### SUMMARY

Systems and methods are described for inspecting/analyzing a data stream to identify one or more attributes of content associated with the data stream, and apply appropriate content filtering based thereon. According to one embodiment, a data stream in a form of one or more interactions between a client device within a private network and a server external to the private network is observed by a network security device associated with the private network. The server is associated with a service provider and delivers, streams or authorizes access to digital content by subscribers of the service provider. At least one attribute of the digital content is identified by the network security device by parsing the data stream. A rating for the digital content is determined by the network security device with reference to a public rating database based on at least one attribute. Access to the digital content by the client device is then blocked or allowed by the network security device by applying a matching content filtering rule based at least on the determined rating.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary overall architecture of a system for content rating identification based on public rating database(s) in accordance with an exemplary embodiment of the present invention.

FIG. 2 illustrates exemplary functional modules of a system for content rating identification based on public rating database(s) and content filtering using a rating-based filtering rule in accordance with an exemplary embodiment of the present invention.

FIG. 3 illustrates an exemplary representation showing content rating identification using a public rating database in accordance with an exemplary embodiment of the present invention.

FIGS. 4A to 4C illustrate exemplary representations showing rating-based content filtering in accordance with an exemplary embodiment of the present invention.

FIGS. 5A and 5B illustrate exemplary sequence charts showing a sequence of rating-based content filtering in accordance with an exemplary embodiment of the present invention.

FIG. 6 is a flow diagram illustrating rating-based content filtering processing in accordance with an exemplary embodiment of the present invention.

FIG. 7 illustrates an exemplary computer system in which or with which embodiments of the present invention may be utilized.

### DETAILED DESCRIPTION

Systems and methods are described for inspecting/analyzing a data stream to identify one or more attributes of content associated with the data stream, and apply appropriate content filtering based thereon. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

### Terminology

Brief definitions of terms used throughout this application are given below.

The phrase “client device” generally refers to a computing device that may access network resources through a network connection. A client device may be an endpoint device within a private network that is protected by a network appliance and is capable of running one or more applications on behalf of an end user. Examples of client devices include, but are not limited to, desktop or laptop personal computers (PCs), handheld computers, tablets and smart phones.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “network security device” generally refers to a hardware device or network appliance configured to protect a private network by providing one or more of data privacy, protection, encryption and security. The network security device can be a device providing one or more of the following features: network firewalling, Virtual Private Networking (VPN), antivirus, intrusion prevention (IPS), content filtering, data leak prevention, anti-spam, anti spyware, logging, reputation-based protections, event correlation, network access control, vulnerability management, load balancing and traffic shaping—that can be deployed individually as a point solution or in various combinations as a unified threat management (UTM) solution. Non-limiting examples of network security devices include proxy servers, firewalls, VPN appliances, gateways, UTM appliances and the like.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

A “server” generally refers to a computer or computer program that manages access to a centralized resource or service in a network. Non-limiting examples of a server include a video server of a streaming or video on demand service provider (e.g., Netflix, Hulu or the like), a game server of an online multiplayer gaming service (e.g., Xbox Live, Nintendo Network, PlayStation Network and Game Centre), a server of a digital media delivery service, a server of a SaaS provider, a server of a cloud application service provider or the like.

Systems and methods are described for inspecting/analyzing a data stream to identify one or more attributes of content associated with the data stream, and apply appropriate content filtering based thereon. In an aspect, a network security device associated with a private network observes a data stream that may be in the form of one or more interactions between a client device within the private network and a computing device placed outside the private network, and identifies at least one attribute of digital content being accessed by client device by parsing the data stream. The network security device further determines, with reference to a public rating database, a rating for the digital content based on the at least one attribute, and blocks or allows access to the digital content by the client device by applying a matching content filtering rule of a plurality of content filtering rules based at least on the determined rating.

In an aspect, the computing device outside the private network can be a server that may be associated with a service provider that delivers streams or authorizes access to digital content by subscribers of the service provider. In an aspect, content being accessed by the client device can be a content stored on external server or a content stored locally on the client device but requiring authentication of external server to access such content.

In an aspect, the plurality of content filtering rules can be defined by an administrator of the private network based on any or a combination of a type of the digital content, an intended audience of the digital content, an environment or location of the intended audience, at least one attribute of the intended audience, and a time of access of the digital content.

In an aspect, the at least one attribute of the digital content can include one or more of metadata associated with the digital content, a title of the digital content, a hash value of the title, a unique identifier of the digital content, an author of the digital content and the service provider.

In an exemplary implementation, the network security device can be a firewall, a gateway device, a unified threat management (UTM) device, an intrusion prevention system (IPS) an intrusion detection system (IDS) and any combination thereof.

In an exemplary embodiment, rating of the content can be determined by assessing a locally cached version of the public rating database, or by sending a query along with at least one attribute associated with content to the public rating database.

In an exemplary embodiment, the digital content can include any or a combination of video content, audio content, gaming content, image-based content and multimedia content. In exemplary implementations, the public database providing rating associated with the content can be a database maintained by a movie or entertainment rating industry committee, organization, association or board. For example, the movie or entertainment rating industry committee, organization, association or board can be the Motion Picture Association of America (MPAA), the Entertainment Software Rating Board (ESRB), the Pan European Game Information (PEGI) or the Computer Entertainment Rating Organization (CERO).

In an exemplary implementation, the network security device can be configured to determine rating of the digital content locally and cross-reference the determined rating with rating retrieved from public rating databases, wherein the rating from public rating database is retrieved by sending query comprising one or more attributes determined by the network security device by observing/analyzing data streams.

In an exemplary implementation, the network security device can be configured to identify one or more attributes from an input/data stream, and send a query comprising the identified one or more attributes for retrieving the rating for the data stream from an appropriate public rating database that is selected from a plurality of available public rating databases.

In exemplary implementation, the system can be configured to allow or block access of both online as well as offline content (which may require access to external server to play the content).

In an aspect, the present disclosure further relates to a system for network content rating based filtering comprising a non-transitory storage device having embodied therein one or more routines operable to facilitate network content rating based filtering; and one or more processors coupled to the non-transitory storage device and operable to execute the one or more routines, wherein the one or more routines include: a data stream receive module, which when executed by the one or more processors, receives a data stream in a form of one or more interactions between a client device within the private network and a server external to the private network, wherein the server is associated with a service provider and delivers, streams or authorizes access to digital content by subscribers of the service provider; a data stream analysis module, which when executed by the one or more processors, identifies at least one attribute of the digital content by parsing the data stream; a rating determination module, which when executed by the one or more processors, determines with reference to a public rating database, a rating for the digital content based on the at least one attribute; and a rule based content filtering module, which when executed by the one or more processors, blocks or allows access to the digital content by the client device by applying a matching content filtering rule of a plurality of content filtering rules based at least on the determined rating.

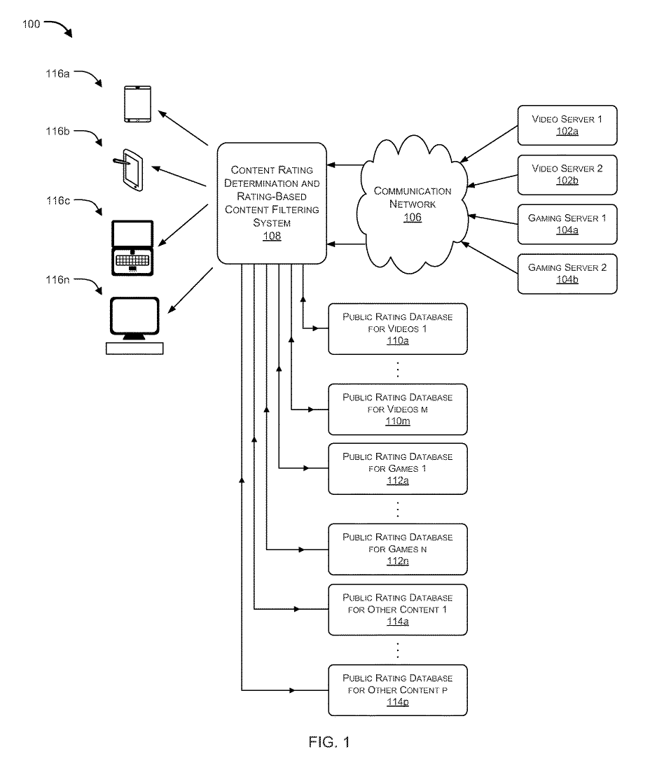

FIG. 1 illustrates an exemplary overall architecture of a system for content rating identification based on public rating database(s) in accordance with an exemplary embodiment of the present invention. As shown in FIG. 1, when a client device 116, for example, a mobile phone 116a, a tablet 116b, a laptop 116c, a desktop computer 116n or any such client device residing within a protected network (also referred as private network) tries to send/receive digital content (which may also be interchangeably referred to as data in motion or streaming data hereinafter) to/from an external computing device 102/104, for example, video server 1 102a, video server 2 102b, gaming server 1 104a, gaming server 2 104b, or any other entity residing outside of the protected network, a content rating determination and rating-based content filtering system 108 protecting the private network and logically interposed between client devices 116a-n and external computing device 102/104 observes a data stream (in a form of one or more interactions between client devices 116a-n and external computing device 102/104), determines one or more attributes of digital content delivered by, streamed by or to which access is authorized by a service provider associated with external computing device 102/104 based on the data stream. Based on the one or more determined attributes, content rating determination and rating-based content filtering system 108, then determines a rating for the digital content using any or a combination of local rating engine and/or public rating database(s), and makes a decision to block or allow the digital content based on any or a combination of the identified rating and predefined content filtering rules.

In an aspect, external computing device 102/104 (which may also be referred to as external device hereinafter) can be any server residing outside the private network. Such a server may be associated with a service provider that delivers streams or authorizes access to digital content by subscribers of the service provider, or can be a server of an aggregator or can be a game hosting server, content distribution server, or a head-end server.

In an exemplary aspect, one or more attributes that can be extracted/retrieved by system 108 from a data stream can include, but is not limited to, metadata associated with the data stream, a title of digital content associated with the data stream, a hash value of the title, a unique identifier of the digital content, an author of the digital content, the service provider, or any other like attribute, all of which individually and in combination are covered within the scope of the present disclosure.

Upon determination of one or more attributes based on an analysis of the data stream, system 108 can identify a rating of the digital content being requested/transmitted, for example, by referring the determined one or more attributes of the data stream to a local rating engine or to a public rating database. In an exemplary implementation, system 108 can locally identify a rating associated with the digital content, and cross-reference the rating with a public rating database based on the one or more attributes determined by system 108. In an exemplary implementation, the rating can be determined by assessing a locally cached version of a public rating database or by sending a query along with at least one attribute associated with the digital content at issue to the public rating database.

As those skilled in the art will appreciate, a network security device implementing functionalities of content rating determination and rating-based filtering system 108 may be represented in a variety of forms, including, but not limited to a proxy server, a firewall, a VPN appliance, a gateway, a Unified Threat Management (UTM) appliance, an Intrusion Detection System (IDS), an Intrusion Prevention System (IPS) and the like.

In an exemplary implementation, system 108 can be coupled with one or more public rating databases, for example, public rating databases for videos 110a-m, public rating database for games 112a-n and public rating databases for other content 114a-p (which may be collectively referred to hereinafter as public rating database(s) 110/112/114). Such public rating databases 110/112/114 that provide ratings associated with digital content can be databases that are maintained by a movie or entertainment rating industry committee, organization, association or board. Non-limiting examples of such movie or entertainment rating industry committees, organizations, associations or boards include the Motion Picture Association of America (MPAA), the Entertainment Software Rating Board (ESRB), the Pan European Game Information (PEGI) and the Computer Entertainment Rating Organization (CERO). Any other such organization/entity that has credibility of rating digital content based on one or more attributes such as a title of the digital content is well within the scope of the present disclosure.

In an aspect, system 108 (which may also be interchangeably referred to as network security device) can send a query, which may include one or more attributes, to at least one public rating database, and receive a rating from the public rating database for corresponding digital content. In an exemplary implementation, network security device can be configured to consider the rating provided by the public rating database as reliable/credible, having been determined over a period of time. In an exemplary implementation, network security device can be configured with a default public database to which it can send the query and from which it can receive the requested rating for the digital content at issue.

In an exemplary embodiment, system 108 can be configured to take action based on an identified rating and/or one or more predefined content filtering policy rules. In an aspect, content filtering rules can be defined by an administrator of a private network based on any or a combination of a type of digital content, an intended audience of the digital content, an environment or location of the intended audience, at least one attribute of the intended audience, and a time of access of the digital content. For example, the administrator can specify by way of the content filtering policy rules that any digital content with an “R” rating by MPAA should not be allowed for users of private network. In another example, the administrator can define the content filtering policy rules such that any digital content having a rating of “NC-17” by the MPAA should not be allowed for users below the age of 18, or for users from Palo Alto, or for users after 10 PM. In an exemplary implementation, content filtering policy rules can be defined for the entire private network, or individually for each user, or for each client device, or for a group of users of the private network. Content filtering policy rules can be defined based on times, type of premises, user groups etc.

As those skilled in the art will appreciate, non-limiting examples of digital content for which system 108 can be configured include any or a combination of video content, audio content, visual content, gaming content, image-based content, multimedia content, or a combination thereof.

In practice, there may be an option in the network security device that provides content filtering to filter content by rating. The network security device can also have a set of rules associated with various ratings on various types of content, which can be defined by an administrator for a private network through a suitable interface. The interface can provide options to the administrator to define rules, possibly using checkboxes as a form of selection and/or drop down menus.

In exemplary implementations, the public rating databases can be local, national or international content rating databases developed based on inputs of local/national or international rating authorities in various geographical regions. In an exemplary implementation, a copy of the public rating databases can be cached locally at the network security device implementing the rating-based content filtering. Such cache can be regularly, periodically, or in real-time updated based on changes in rating patterns by public rating databases or based on changes in rating based content filtering rules.

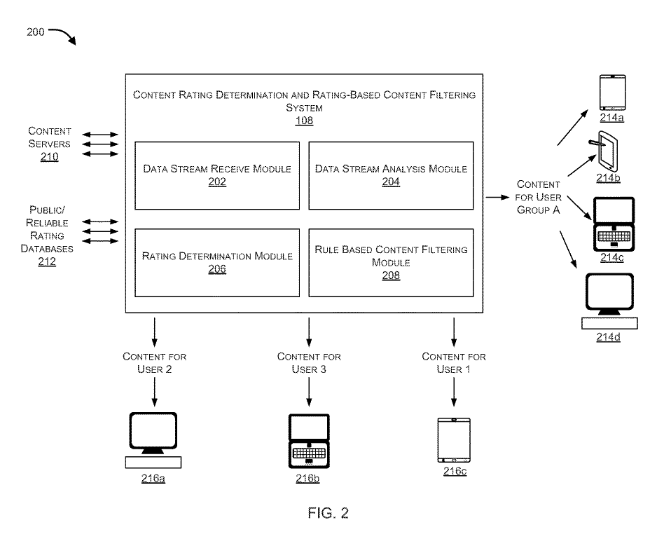

FIG. 2 illustrates exemplary functional modules of a system 108 for content rating identification based on public rating database(s) and content filtering using a rating-based filtering rule in accordance with an exemplary embodiment of the present invention. System 108 can include various functional modules that can be implemented within a network security device. In an aspect, functional modules of system 108 can include a data stream receive module 202 configured to capture data streams related to digital content being requested by a client device, for example by a mobile device 214a, a tablet 214b, a laptop 214c, or a desktop computer 214d (which may be collectively referred to as client device 214), from content server(s) 210, and a data stream analysis module 204 configured to determine at least one attributes of the associated digital content based on data stream analysis. System 108 can further include a rating determination module 206 configured to identify a rating of the digital content by referring to public/reliable rating databases 212, and a rule based content filtering module 208 configured to determine whether the digital content should be allowed or blocked based on the identified rating and predefined content filtering rules.

In an exemplary implementation, system 108 can be configured to allow or block access of both online as well as offline content that requires access to an external server in order to play the content.

In an exemplary implementation, data stream receive module 202 can capture a data stream related to a new content request (new digital content) or a transfer session initiated by a client device 214 that forms part of a private network. Data stream, in the form of one or more interactions between client device and an external device, for example, a content server, can be captured by module 202 from live traffic. In an aspect, the network security device can be configured to monitor content access requests or content transfer requests originating from users or client devices of a private network. For example, network security device can monitor content assess requests from client device 216a, client device 216b, and client device 216c.

In an exemplary implementation, data stream analysis module 204 implemented within network security device can observe and analyze a data stream to identify at least one attribute of the associated digital content by parsing the data stream. The data stream, being captured, can be in the form of one or more interactions between client device and server, wherein the server can be associated with a service provider and delivers, streams or authorizes access to digital content by subscribers of the service provider. Data stream analysis module 204, based on the analysis, can determine at least one attribute of the digital content. In an exemplary implementation, module 204 can be configured to specifically analyze such data streams that are associated with communication session being established with a known content publishing server, head-end, or game-hosting server, for example. In an exemplary implementation, module 204 can detect an IP address and/or a port that is used for video streaming or gaming specifically, and further by correlating with other data streams and historical data, can determine an attribute, for example, a title of the digital content at issue. In exemplary implementations, attributes of the digital content can include, but are not limited to, metadata associated with the digital content, a title of the digital content, a hash value of the title, a unique identifier of the digital content, an author of the digital content, and the service provider. Module 204 can determine or extract attributes from data stream representing either or both of a request from the client device to the server and a response from the server to the client device.

In an exemplary implementation, rating determination module 206 can enable the network security device to determine, with reference to a public rating database, a rating for the digital content based on the at least one determined attribute (by module 204). In an exemplary implementation, module 206 can identify a rating by using a rating determination engine that runs on the network security device, and cross-verify the rating from a public rating database 212. In another aspect, a rating, based on the at least one attribute, can be identified locally at the network security device, and can be cross-verified by the public rating database. Module 206 can further be configured to determine a rating for the digital content by referring to a locally cached database of a public rating database. In yet another aspect, module 206 can send a query having the at least one determined attribute to a public rating database to retrieve the rating associated with the digital content at issue. For example, as the attribute can be a title of the digital content, the title can be sent to a rating database 212 such as a rating database maintained by the MPAA, based on which the database can respond with a rating of the digital content (e.g., G, PG, PG-13, R, or NC-17).

In an exemplary implementation, rule based content filtering module 208 can be configured to block or allow access to or transfer of the digital content by the client device by applying a matching content filtering rule of the content filtering rules implemented by the network security device based at least on the determined rating. The content filtering rules can be created/defined by an administrator of a private network based on any or a combination of a type of the digital content, an intended audience of the digital content, an environment or location of the intended audience, at least one attribute of the intended audience, and a time of access of the digital content. In an exemplary implementation, module 208 can allow or block an access request for digital content by the client device as defined by the identified rating of the digital content and the rating-based policy rules.

In an embodiment, system 108 can enable a network administrator to define content filtering rules for individual client devices, for users of the private network and/or for groups of users. System 108 can also allow administrator to select a setting that allows a set of rules created for a client device, user or group to be replicated/updated/revised/added/deleted for another client device, user or group thereof. In an exemplary implementation, system 108 can allow the administrator to define content filtering rules that can be applied universally to client devices that form part of the private network, as well as a more specific set of content filtering rules that can be applied for a particular type of client device or a group of users.

Although various embodiments have been explained with respect to content being requested by a client device, and allowing/blocking such requests or delivery of the content based on identified rating by referring to a public rating database, system and method of present disclosure can be used for content filtering or access request filtering for other types of “data in motion” (e.g., interactions between a browser and an external video server associated with a video streaming service, interactions between a gaming system platform and an external game server to allow a gamer to play a locally stored digital rights management (DRM)-protected game and interactions with Software as a Service (SaaS) and cloud applications to access services) as well.

For example, when a user of a client device utilizes a web browser (e.g., Google Chrome) to access a streaming service (e.g., Netflix) an outbound request is made from the client's browser to receive content from Netflix. Netflix sends a request back to the client device to activate a browser plug-in (e.g., a Microsoft Silverlight plug in). Once the client device confirms availability of the Microsoft Silverlight plugin, Netflix's video server establishes a connection and begins sending streaming video data to the client device. System 108 can determine that the client device is using the Chrome browser, accessing the netflix.com domain, that the browser is running the MS Silverlight plug-in and has established a connection with an external server. Based on this information, data steam analysis module of system 108 can inspect the data stream, and parse the data stream to determine at least one attribute, for example a title of the content being requested from a Netflix server. The system 108 can determine the title of the content as it is generally displayed on the client device and is also logged in both Silverlight and Chrome. The title can also be located by the network security device within the client device's initial outbound request to a streaming or video on demand service provider (e.g., Netflix, Hulu or the like). For example, the existence of a known Representational State Transfer (REST)-based Application Programming Interface (API) call, Java API call or the like within a Hypertext Transfer Protocol (HTTP) request may be identified by performing pattern matching against the HTTP request and extracting data associated with the field of interest (e.g., the title). Once the title is determined, system 108 can send a query to a public rating database 212, for example one maintained by the MPAA that contains movie ratings, to determine a rating for the digital content based on the determined attribute (e.g., the title). Responsive to receiving the requested rating from the public rating database system 108, can then identify whether any rule/policy is applicable to digital content having such a rating, based on which system 108 makes a decision to allow or block the content streaming. For example, if the rating of the title is determined as being “R”, and the rating based content filtering rule indicates that the content streaming for “R” rated content should be blocked, system 108 can block the access request for such title.

Similarly, system 108 can also determine a rating of a video game being played by client device, and based on rating-based content filtering rules, take an action of allowing or blocking such game on the client device. For example when a client device (e.g., an Xbox game console) is used for playing a Digital Rights Management (DRM) protected program that has been booted off a disk, system 108 can determine the rating of such DRM protected program, for example, a game and block or allow the game based on the determined rating and a matching rating-based content filtering rule. As a game may have an online play functionality, requiring it to establish a connection to an external game server, when game play is requested, client device (e.g., an Xbox game console) will typically transmit certain information (e.g., a hash value that identifies the game title) to an external game server or to a game hosting computer. System 108 can determine/identify a specific attribute, for example, the title of the game, identify a rating based on the determined title from a publicly maintained rating database (e.g., in the United States, it may be a ratings database maintained by the ESRB) such that once a rating from a publically available database is identified, rules can be enforced to prevent or allow the DRM protected game.

System 108 can determine any other specific attributes, for example metadata associated with the digital content, a hash value of a title of the digital content, a unique identifier of the digital content, an author of the digital content, and a service provider from analysis of the data stream. For example, in the context of the Xbox scenario described above, assuming calls to the Xbox API are generally in the form of https://xboxapi.com/v2/{xuid}/{endpoint}, wherein xuid is the Xbox Account User ID and endpoint is the call being made, pattern matching can be used to capture the desired endpoint and extract the desired data.

Similarly, system 108 can be configured to control access request for any digital content such as video content, audio content, gaming content, image-based content, and multimedia content.

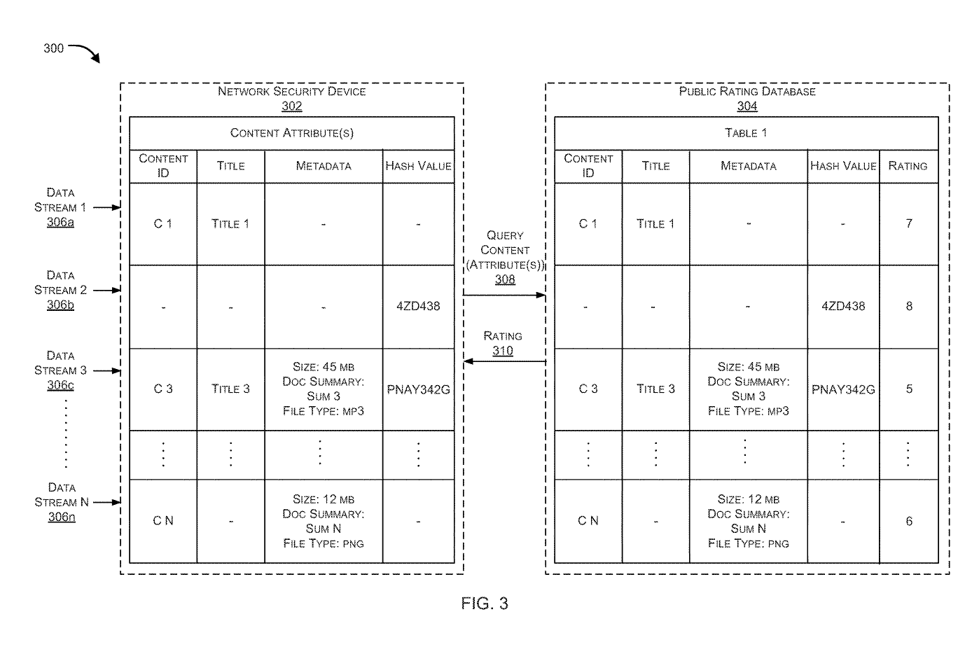

FIG. 3 illustrates an exemplary representation showing content rating identification using a public rating database in accordance with an exemplary embodiment of the present invention. As shown in FIG. 3, a network security device 302 receives data streams, for example, data stream 1 306a, data stream 2 306b, data stream 3 306c, . . . , data stream N 306n (which may be collectively referred to as data stream(s) 306 hereinafter), and analyzes these data streams to determine one or more attributes of interest. For each request being initiated by any of the client devices of protected network, network security device 302 can determine one or more attributes associated with digital content being requested from known video streaming services, gaming system services and apply content filtering rules at line speed. Exemplary content attributes can include a content identifier (ID), a title, metadata, hash values, etc., which can be determined by parsing each data stream 306. For different content requests, network security device 302 can determine different content attributes. For example, it is possible that the network security device 302 determines title of associated digital content for a first connection request, a hash value for a second connection request, metadata for a third connection request, and multiple attributes for a fourth connection request from data stream(s) of respective connection requests. FIG. 3 illustrates an exemplary logical table that presents content attributes that can be determined by parsing data stream 306. In an exemplary implementation, upon determination of at least one content attribute, network security device 302 can send a query 308 having the at least one content attribute to public rating database 304 so as to identify a corresponding rating for the digital content associated with the data stream from which the attribute was extracted. As shown in FIG. 3, a public rating database 304 can maintain ratings for digital content along with logical mappings of different attributes of the content. Upon receiving query 308 having the content attribute (e.g., a title of the digital content), public rating database 304 can provide, to network security device 302, a rating 310 for the digital content being requested, for example, by client device. Network security device 302 can then refer to one or more configured rating based content filtering rules so as to determine an appropriate action (e.g., allow, block, log, alert, etc.) to take on the request and/or subsequent packets associated with the flow. In an aspect, network security device 302 can refer to rating-based content filtering rules defined for each user so as to make to a decision on whether to allow or block the content based on the identified rating.

In exemplary implementations, rule-based content filtering rules can be defined based on any or a combination of a type of digital content, an intended audience of the digital content, an environment or location of the intended audience (e.g., an elementary school, a middle school, a high school, a college, a public library, etc.), at least one attribute of the intended audience (e.g., age), and a time of access of the digital content.

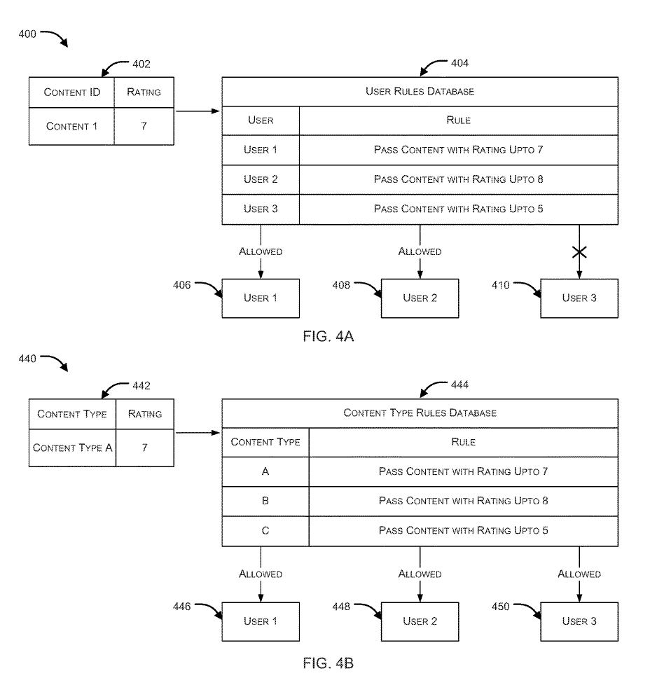

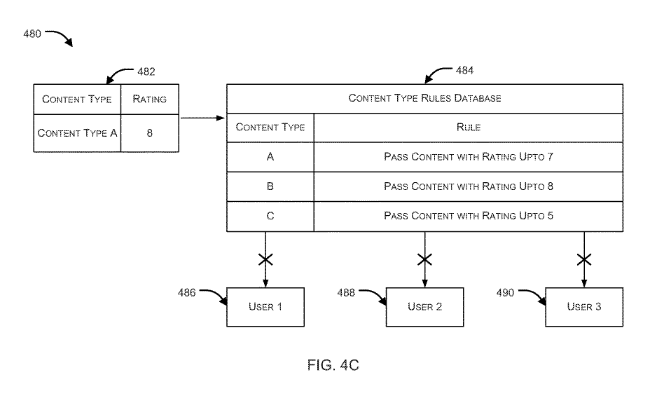

FIGS. 4A to 4C illustrate exemplary representations showing rating-based content filtering in accordance with an exemplary embodiment of the present invention. In these examples, for sake of discussion content is assumed to have a rating on a scale of 1 to 10. FIG. 4A shows a user-based rules database 404 storing user-level rules, wherein database 404 can either be maintained by network security device or by another network device that is operatively coupled with the network security device. As shown, for a determined content attribute/identifier (content ID) 402 and its respective rating of 7, upon referring to the user-based rules stored in database 404, network security device can allow access to the content by user 1 406 and to user 2 408, but can block the same content if it is attempted to be accessed by user 3 410 as only content with a rating of up to 5 can be viewed by user 3.

FIG. 4B shows a content type-based rules database 444 storing content type-based rules, wherein database 444 can either be maintained by network security device or by another network device that is operatively coupled with the network security device. As shown, for a determined content type A and its respective rating of 7, upon referring to the content type-based rules stored in database 444, network security device can allow access to the content to all three users, user 1 446, user 2 448, and user 3 450 as rule for Content Type A states that the content can be passed to all users for ratings of 1 to 7, and therefore as the rating in the instant case is 7, the users are permitted to access the content.

FIG. 4C shows another case of a content type-based rules database 484 storing content type-based rules, wherein database 484 can either be maintained by network security device or by another network device that is operatively coupled with the network security device. As shown, for a determined content type A and its respective rating of 8, upon referring to the content type-based rules stored in database 484, network security device denies access to the content to all the three users, user 1 486, user 2 488, and user 3 490 as the rule for Content Type A states that the content is permitted for all users for a rating of 1 to 7, and therefore as the rating in the instant case is 8, access to the content is blocked for all three users.

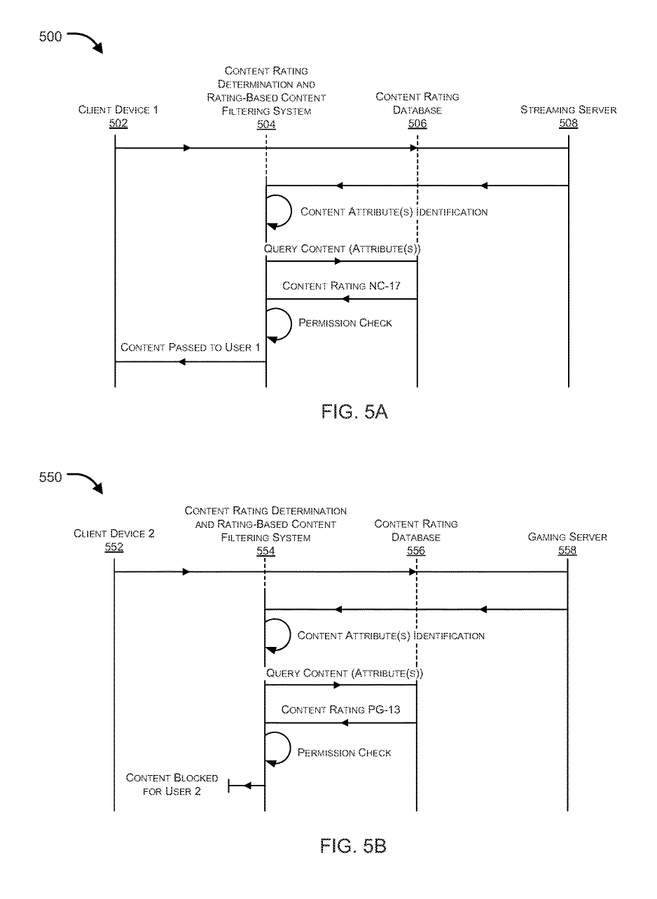

FIGS. 5A and 5B illustrate exemplary sequence charts showing a sequence of content rating-based filtering in accordance with an exemplary embodiment of the present invention. As shown in FIG. 5A, when a client device 1 502 tries to access content (e.g., streaming content from Netflix, for instance) by making a request to a streaming server 508, content rating determination and rating-based content filtering system 504 can capture and inspect the data stream in a form of one or more interactions between client device 502 within a private network and streaming server 508 that is external to the private network, and accordingly perform content attribute(s) identification by parsing the data stream. Responsive to identification/determination of at least one attribute, system 504 can send a query including the at least one content attribute to a content rating database 506, which can return a rating of the content being requested. System 504 can further check for permission or content filtering rules, and take appropriate action on this and subsequent packets associated with the flow based on a matching content filtering rule. For example, a decision regarding whether to allow or block access to the content by client device 1 502 may be determined based on the identified rating, the content filtering rules and one or more of an identify of the user, a group of users with which the user is associated, a time of day, a location of the user, one or more other attributes of the user, among other factors.

For example, when a user, through client device 502, sends a request to streaming server 508 to initiate streaming of a movie, the title (e.g., “Titanic”) of the requested content/movie can be extracted from the data stream by system 504 and sent to MPAA public rating database as part of a content rating query, which can, based on the title, return the rating (e.g., PG-13). Based on this rating and at least one attribute of the user/content/time, system 504 can, using one or more content filtering rules, decide whether to allow or disallow the user to view the content.

FIG. 5B illustrates another example where a user, through his/her client device 2 552, tries to access content, say a game having all executables locally available on the client device 552 itself but which requires authentication by gaming server 558. In such case, when the user tries to play the game, client device 552 sends an authentication request to game server 558. System 554 inspects a data stream associated with the authentication request and performs content attribute(s) identification. System 554, upon determination of at least one content attribute (e.g., a hash value of the game title), can send a query including the at least one content attribute to a content rating database 556, which can have ratings of different games so as to identify a rating of the game being accessed/requested by client device 552. Content rating database 556 can accordingly return the rating of the game in response to the query, based on which, system 554 can apply one or more content filtering rules and take appropriate action based on a matching content filtering rule, thereby making a decision to, among other things, block access to the game on client device 552 or allow user to play the game. In an exemplary implementation, based on the rules, system 554 can block one or more ports and/or interfaces of client device 552 that are required to run the game.

Although, systems have been described with respect to streaming content and gaming content, one may appreciate that system of present disclosure can be used for allowing or blocking any type of content. System and method of the present disclosure can be configured to allow or block any outbound, inbound traffic as well as execution of any program/content on client device.

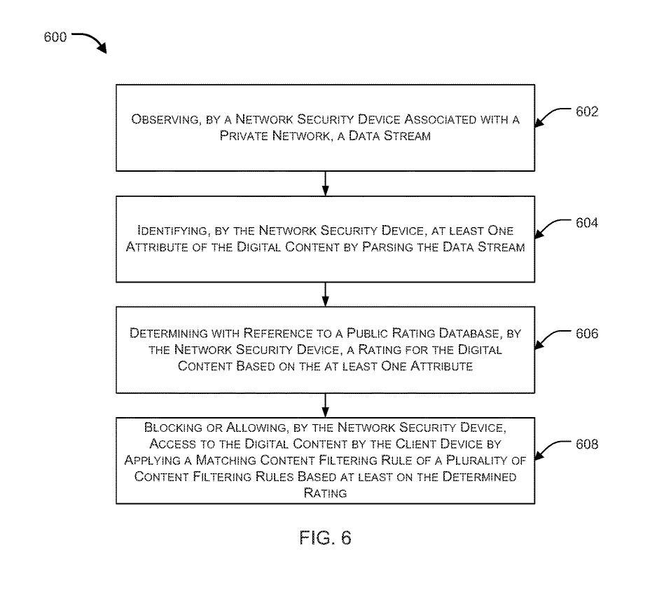

FIG. 6 illustrates by an exemplary flow diagram illustrating rating-based content filtering processing in accordance with an exemplary embodiment of the present invention. As shown in FIG. 6, the method for content rating based filtering includes the steps of observing, by a network security device associated with a private network, a data stream as shown at step 602; identifying, by the network security device, at least one attribute of the digital content by parsing the data stream as shown at step 604; determining with reference to a public rating database, by the network security device, a rating for the digital content based on the at least one attribute shown at step 606; and blocking or allowing, by the network security device, access to the digital content by the client device by applying a matching content filtering rule of a predefined and/or configurable set of content filtering rules based at least on the determined rating as shown at step 608. In an exemplary implementation, the data stream can be in the form of one or more interactions between a client device within the private network and a server external to the private network, wherein the server is associated with a service provider and delivers, streams or authorizes access to digital content by subscribers of the service provider.

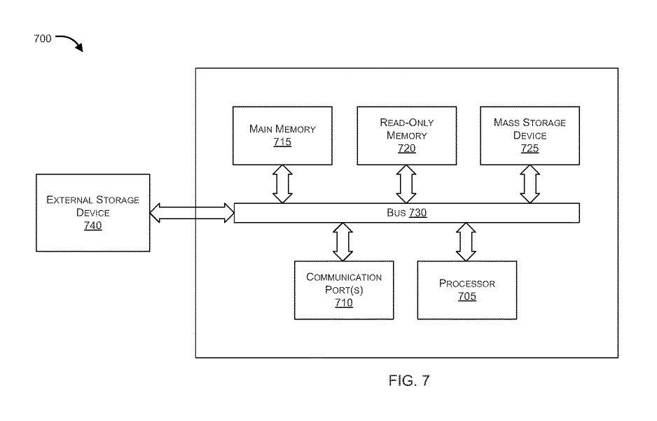

FIG. 7 is an exemplary computer system in which or with which embodiments of the present invention may be utilized. In an embodiment, the computer system 700 represents a network security device that, among other things, performs content filtering based on publicly available content rating databases. Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown in the figure, computer system 700 includes an external storage device 710, a bus 720, a main memory 730, a read only memory 740, a mass storage device 750, communication port 760, and a processor 770. Those skilled in the art appreciate that computer system 700 may include more than one processor and communication ports.

Examples of processor 770 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 770 may include various modules associated with embodiments of the present invention.

Communication port 760 can be any of an RS-232 port for use with a modem based dialup connection, a 10/100 Ethernet port, a Gigabit or 10 Gigabit port using copper or fiber, a serial port, a parallel port, or other existing or future ports. Communication port 760 may be chosen depending on a network, such a Local Area Network (LAN), Wide Area Network (WAN), or any network to which computer system 700 connects.

Memory 730 can be Random Access Memory (RAM), or any other dynamic storage device commonly known in the art. Read only memory 740 can be any static storage device(s) e.g., but not limited to, a Programmable Read Only Memory (PROM) chips for storing static information e.g., start-up or BIOS instructions for processor 770. Mass storage 750 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

Bus 720 communicatively couples processor(s) 770 with the other memory, storage and communication blocks. Bus 720 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 770 to software system. Optionally, operator and administrative interfaces, e.g. a display, keyboard, and a cursor control device, may also be coupled to bus 720 to support direct operator interaction with computer system 700. Other operator and administrative interfaces (not shown) can be provided through network connections connected through communication port 710.

External storage device 740 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). Components described above are meant only to exemplify various possibilities. In no way should the aforementioned exemplary computer system limit the scope of the present disclosure.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method comprising:
observing, by a network security device associated with a private network, a data stream in a form of one or more interactions between a client device within the private network and a server external to the private network, wherein the server is associated with a service provider and delivers, streams or authorizes access to digital content by subscribers of the service provider;
identifying, by the network security device, at least one attribute of the digital content by parsing the data stream;
determining with reference to a public rating database, by the network security device, a rating for the digital content based on the at least one attribute; and
blocking or allowing, by the network security device, access to the digital content by the client device by applying a matching content filtering rule of a plurality of content filtering rules based at least on the determined rating.

2. The method of claim 1, wherein the plurality of content filtering rules are defined by an administrator of the private network based on any or a combination of a type of the digital content, an intended audience of the digital content, an environment or location of the intended audience, at least one attribute of the intended audience, and a time of access of the digital content.

3. The method of claim 1, wherein the at least one attribute of the digital content comprises one or more of metadata associated with the digital content, a title of the digital content, a hash value of the title, a unique identifier of the digital content, an author of the digital content and the service provider.

4. The method of claim 1, wherein the network security device comprises any or a combination of a firewall, a gateway device, a unified threat management (UTM) device, an intrusion prevention system (IPS) and an intrusion detection system (IDS).

5. The method of claim 1, wherein said determining with reference to a public rating database comprises accessing, by the network security device, a locally cached version of the public rating database.

6. The method of claim 1, wherein said determining with reference to a public rating database comprises querying, by the network security device, the public rating database.

7. The method of claim 1, wherein the digital content comprises any or a combination of video content, audio content, gaming content, image-based content and multimedia content.

8. The method of claim 1, wherein the public rating database comprises a database maintained by a movie or entertainment rating industry committee, organization, association or board.

9. The method of claim 8, wherein the movie or entertainment rating industry committee, organization, association or board comprises the Motion Picture Association of America (MPAA), the Entertainment Software Rating Board (ESRB), the Pan European Game Information (PEGI) or the Computer Entertainment Rating Organization (CERO).

10. A system for network content rating based filtering comprising:
a non-transitory storage device having embodied therein one or more routines operable to facilitate network content rating based filtering; and
one or more processors coupled to the non-transitory storage device and operable to execute the one or more routines, wherein the one or more routines include:
a data stream receive module, which when executed by the one or more processors, receives a data stream in a form of one or more interactions between a client device within the private network and a server external to the private network, wherein the server is associated with a service provider and delivers, streams or authorizes access to digital content by subscribers of the service provider;
a data stream analysis module, which when executed by the one or more processors, identifies at least one attribute of the digital content by parsing the data stream;
a rating determination module, which when executed by the one or more processors, determines with reference to a public rating database, a rating for the digital content based on the at least one attribute; and
a rule based content filtering module, which when executed by the one or more processors, blocks or allows access to the digital content by the client device by applying a matching content filtering rule of a plurality of content filtering rules based at least on the determined rating.

11. The system of claim 10, wherein the plurality of content filtering rules are defined by an administrator of the private network based on any or a combination of a type of the digital content, an intended audience of the digital content, an environment or location of the intended audience, at least one attribute of the intended audience, and a time of access of the digital content.

12. The system of claim 10, wherein the at least one attribute of the digital content comprises one or more of metadata associated with the digital content, a title of the digital content, a hash value of the title, a unique identifier of the digital content, an author of the digital content and the service provider.

13. The system of claim 10, wherein the network security device comprises any or a combination of a firewall, a gateway device, a unified threat management (UTM) device, an intrusion prevention system (IPS) and an intrusion detection system (IDS).

14. The system of claim 10, wherein said rating determination module is further configured to access a locally cached version of the public rating database.

15. The system of claim 10, wherein said rating determination module is further configured to query the public rating database.

16. The system of claim 10, wherein the digital content comprises any or a combination of video content, audio content, gaming content, image-based content and multimedia content.

17. The method of claim 1, wherein the public rating database comprises a database maintained by a movie or entertainment rating industry committee, organization, association or board.

18. The method of claim 8, wherein the movie or entertainment rating industry committee, organization, association or board comprises the Motion Picture Association of America (MPAA), the Entertainment Software Rating Board (ESRB), the Pan European Game Information (PEGI) or the Computer Entertainment Rating Organization (CERO).

19. A network security device for network content rating based filtering comprising:
a non-transitory storage device having embodied therein one or more routines operable to facilitate network content rating based filtering; and
one or more processors coupled to the non-transitory storage device and operable to execute the one or more routines, wherein the one or more routines include:
a data stream receive module, which when executed by the one or more processors, receives a data stream in a form of one or more interactions between a client device within the private network and a server external to the private network, wherein the server is associated with a service provider and delivers, streams or authorizes access to digital content by subscribers of the service provider;
a data stream analysis module, which when executed by the one or more processors, identifies at least one attribute of the digital content by parsing the data stream;
a rating determination module, which when executed by the one or more processors, determines with reference to a public rating database, a rating for the digital content based on the at least one attribute; and
a rule based content filtering module, which when executed by the one or more processors, blocks or allows access to the digital content by the client device by applying a matching content filtering rule of a plurality of content filtering rules based at least on the determined rating.
